(19) United States
(12) Patent Application Publication
(10) Pub. No.: US 2014/0306958 A1
(43) Pub. Date: Oct. 16, 2014

(54) STEREOSCOPIC RENDERING SYSTEM

(71) Applicant: Dynamic Digital Depth Research Pty Ltd, Bentley (AU)

(72) Inventors: Julien Charles Flack, Swanbourne (AU); Hugh Sanderson, Shenton Park (AU)

(73) Assignee: Dynamic Digital Depth Research Pty Ltd, Bentley (AU)

(21) Appl. No.: 14/248,639

(22) Filed: Apr. 9, 2014

(30) Foreign Application Priority Data
Apr. 12, 2013 (AU) 2013901259

(51) Int. Cl. G06T 15/00

(52) U.S. Cl. CPC G06T 15/005
USPC 345/422

(57) ABSTRACT

A stereoscopic rendering system is disclosed that comprises a depth buffer having at least two depth buffer portions respectively corresponding to different views of a scene, the depth buffer arranged to store depth values indicative of the depth of pixels in a scene, and the depth buffer portions having different associated depth value ranges so that the different depth buffer portions are distinguishable from each other. The system also includes an image buffer arranged to store information indicative of an image to be displayed. The system is arranged to apply a different depth test for each view of the scene such that only pixels of the view that spatially correspond to the depth buffer portion associated with the view are rendered to the image buffer. The image rendered into the image buffer comprises image portions respectively spatially corresponding to the different depth buffer portions and the different views of the scene.

### CROSS REFERENCE TO RELATED APPLICATIONS

This application claims priority to Australian Patent Application Serial No. 2013901259, filed Apr. 12, 2013, which is incorporated herein by reference in its entirety.

### FIELD OF THE INVENTION

The present invention relates to a stereoscopic rendering system and to a method of rendering stereoscopic images.

### BACKGROUND

In order to provide a viewer of a scene with the appearance of 3D, it is necessary to produce views of the scene from slightly different observation points and present the views to respective eyes of the viewer. One way of presenting such views involves generating an image having portions associated with a left eye and portions associated with a right eye, for example as alternate stripes, and providing a viewing system arranged to direct respective left and right views to the correct eye. Typically, such viewing systems use a parallax barrier to enable the correct views to be directed to the correct eyes.

An example prior art stereoscopic rendering system is shown in FIGS. 1 and 2 and an example prior art method of rendering stereoscopic images is shown in FIGS. 3 and 4.

The prior art system includes a 3D enabled display 10 arranged to facilitate generation of an image having portions associated with a left eye view and portions associated with a right eye view. An enlarged portion 12 of the display 10 shows that the display 10 in this example includes alternate left and right vertical stripes 14, 16 in which each RGB sub-pixel is assigned a view number that corresponds to the respective left or right vertical stripe.

In this example, a parallax barrier 18 is used to enable correct views to be directed to left and right eyes.

A diagrammatic representation of the prior art rendering system 20 shown in relation to a graphics primitive 22 desired to be rendered stereoscopically is shown in FIG. 2.

The rendering system 20 includes a left virtual camera 24 arranged to produce an image of the graphics primitive 22 from a first (left eye) viewpoint, a left off-screen buffer 26 into which the image is rendered as a left view 28, and a left mask 30 that is striped and configured such that only portions of the left view 28 aligned with the left view stripes are rendered into a display buffer 32.

Similarly, the rendering system 20 includes a right virtual camera 34 arranged to produce an image of the graphics primitive 22 from a second (right eye) viewpoint, a right off-screen buffer 36 into which the image is rendered as a right view 38, and a right mask 40 that is striped and configured such that only portions of the right view 38 aligned with the right view stripes are rendered into the display buffer 32.

The rendering system also includes an interleaver 44 arranged to combine the striped portions of the left and right views 28, 38 into a combined view 42 that is rendered into the display buffer 32.

A flow diagram 50 illustrating steps 52-70 of a prior art method of rendering stereoscopic images is shown in FIG. 3, and a flow diagram 80 illustrating example steps 82-92 for combining images in two or more off-screen buffers into a display buffer as part of the method illustrated in FIG. 3 is shown in FIG. 4.

The flow diagrams 50, 80 contemplate stereoscopic rendering systems that produce more than two views, although more commonly for current glasses free and glasses based 3D displays only two views are produced for respective left and right eyes of a viewer.

It will be appreciated that with the prior art system and method shown in FIGS. 1 to 4 it is necessary to first render two separate views of a scene into two separate buffers prior to masking the views and interleaving to produce a combined view that is rendered to the display buffer. As a consequence, the computational burden to render in stereoscopic 3D can be considerable to the extent that the performance capacity of the rendering system can be exceeded. This can lead to reductions in frame rate and ultimately, at least for gaming applications, loss in interactivity and responsiveness.

In order to minimize the computational burden of rendering in stereoscopic 3D, a stencil buffer has been used to render left and right views of a scene directly into the display buffer. This process provides performance improvements relative to the above system and method shown in FIGS. 1 to 4, since only the pixels required by the final display buffer are rendered.

However, this technique is only possible if the stencil buffer is not already being used for other purposes (for example drawing shadows, reflections and so on). Also, for rendering systems that do not already include a stencil buffer, additional memory is required from the rendering system that might not readily be available.

### SUMMARY

In accordance with a first aspect of the present invention, there is provided a stereoscopic rendering system comprising: a depth buffer having at least two depth buffer portions respectively corresponding to different views of a scene, the depth buffer arranged to store depth values indicative of the depth of pixels in a scene, and the depth buffer portions having different associated depth value ranges so that the different depth buffer portions are distinguishable from each other; and an image buffer arranged to store information indicative of an image to be displayed; wherein the system is arranged to apply a different depth test for each view of the scene such that only pixels of the view that spatially correspond to the depth buffer portion associated with the view are rendered to the image buffer; and wherein the image thereby rendered into the image buffer comprises image portions respectively spatially corresponding to the different depth buffer portions and the different views of the scene.

In an embodiment, the depth buffer portions include a first set of depth buffer portions and a second set of depth buffer portions alternately disposed relative to the first set of depth buffer portions.

In an embodiment, the alternate first and second sets of depth buffer portions comprise stripes that may extend vertically or horizontally.

In an embodiment, two sets of depth buffer portions are provided respectively corresponding to left and right views of a scene.

In an embodiment, the depth value range for the first set of depth buffer portions is numerically adjacent the depth value range for the second set of depth buffer portions.

In an embodiment, the depth value range for the first set of depth buffer portions is 0-0.5, and the depth value range for the second set of depth buffer portions is 0.5-1.

In an embodiment, the system is arranged such that increasing magnitude depth values in the first set of depth buffer portions is indicative of increasing closeness to the foreground of a scene, and decreasing magnitude depth values in the second set of depth buffer portions is indicative of increasing closeness to the foreground of a scene.

In an embodiment, the system is arranged to apply a depth test to a first view of a scene such that only pixels associated with the first view of the scene that have a depth value greater than the corresponding depth value in the depth buffer and within the depth range for the first set of depth buffer portions are rendered to the image buffer.

In an embodiment, the system is arranged to apply a depth test to a second view of a scene such that only pixels associated with the second view of the scene that have a depth value less than the corresponding depth value in the depth buffer and within the depth range for the second set of depth buffer portions are rendered to the image buffer.

In an embodiment, the system is arranged to replace the depth value in a depth buffer portion with a depth value associated with a pixel of a view of a scene if the depth value associated with the pixel passes the depth test associated with the view of the scene.

In an embodiment, the system is arranged to initialize the depth buffer portions by populating the depth buffer portions with defined initial depth values.

The defined initial depth value for the first set of depth buffer portions may be 0, and the defined initial depth value for the second set of depth buffer portions may be 1.

In an embodiment, an overlay depth value or overlay depth value range different to the depth value ranges associated with the at least two depth buffer portions is defined, and the system arranged to render pixels that have a depth value corresponding to the overlay depth value or falling within the overlay depth value range from any of the views to the image buffer.

In an embodiment, the overlay depth value range is defined between the depth ranges associated with the first and second sets of depth buffer portions.

In an embodiment, the system comprises a display buffer arranged to store information indicative of an image to be displayed by a display, and the image buffer comprises a back buffer in which image information is initially rendered prior to transference to the display buffer.

In an embodiment, the stereoscopic rendering comprises an anti-aliasing system, the anti-aliasing system arranged to generate a second image using a first image rendered into the image buffer, and to generate a smoothed image using the first and second images.

In an embodiment, the second image is generated by spatially shifting the first image.

In an embodiment, the anti-aliasing system is arranged to generate a smoothed image by combining spatial and/or temporal sampling intervals.

In an embodiment, multiple temporally spaced images are produced and the multiple temporally spaced images used to produce a smoothed image.

In accordance with a second aspect of the present invention, there is provided a method of rendering stereoscopic images, the method comprising: providing a depth buffer having at least two depth buffer portions respectively corresponding to different views of a scene; storing in the depth buffer depth values indicative of the depth of pixels in a scene, the depth buffer portions having different associated depth value ranges so that the different depth buffer portions are distinguishable from each other, and the depth buffer portions being arranged so as to conform with a view arrangement of an associated 3D display system; providing an image buffer arranged to store information indicative of an image to be displayed; and applying a different depth test for each view of the scene such that only pixels of the view that spatially correspond to the depth buffer portion associated with the view are rendered to the image buffer; wherein the image thereby rendered into the image buffer comprises image portions respectively spatially corresponding to the different depth buffer portions and the different views of the scene.

In accordance with a third aspect of the present invention, there is provided a computer readable medium storing a computer program arranged when loaded into a computing device to cause the computing device to operate in accordance with a stereoscopic rendering system according to the first aspect of the present invention.

### BRIEF DESCRIPTION OF THE DRAWINGS

The present invention will now be described, by way of example only, with reference to the accompanying drawings, in which:

FIG. 1 is a diagrammatic representation of a 3D enabled display used in accordance with a prior art stereoscopic rendering system;

FIG. 2 is a diagrammatic representation of a prior art stereoscopic rendering system;

FIG. 3 is a flow diagram illustrating steps of a prior art method of stereoscopic rendering;

FIG. 4 is a flow diagram illustrating steps of a prior art method of combining views in two or more off-screen buffers into a display buffer as part of the method illustrated in FIG. 3;

FIG. 5 is a block diagram illustrating a stereoscopic rendering system in accordance with an embodiment of the present invention;

FIG. 6 is a flow diagram illustrating steps of a method of stereoscopic rendering in accordance with an embodiment of the present invention;

FIG. 7 is a flow diagram illustrating an example method of rendering stereoscopic images in a system that produces two views of a scene;

FIG. 8 is a diagrammatic representation of a stereoscopic rendering system in accordance with an embodiment of the present invention; and

FIG. 9 is a diagrammatic representation of an example anti-aliasing system of the stereoscopic rendering system shown in FIGS. 5 to 8.

### DETAILED DESCRIPTION

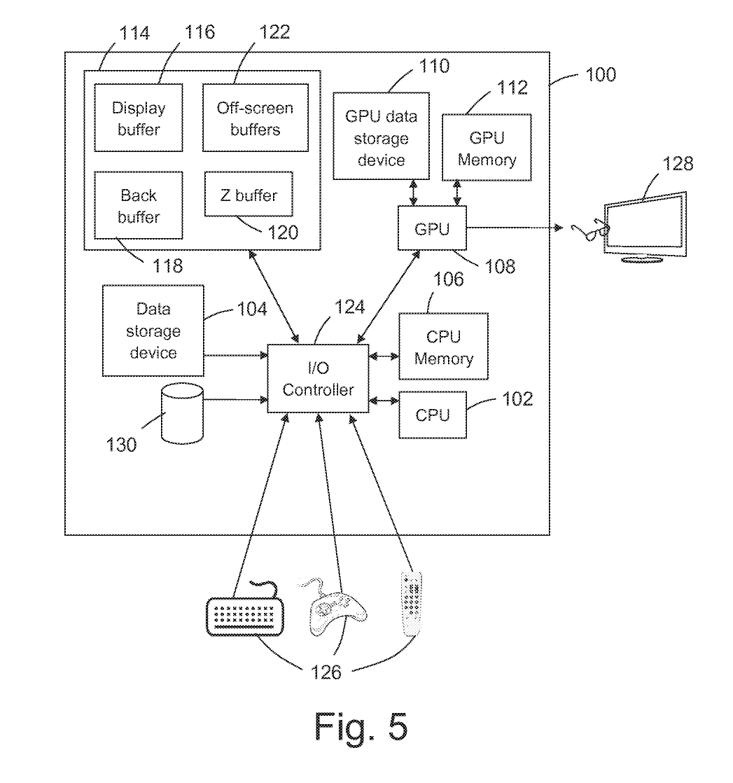

Referring to FIG. 5 of the drawings, there is shown a stereoscopic rendering system 100, in this example forming part of a 3D enabled device such as a smartphone, a gaming system console or personal computing device arranged to implement one or more 3D games. The system 100 is connected to user interface devices 126 for controlling operation of the gaming system or computing device, and a 3D enabled display 128. However, while the present embodiments are described in relation to a smartphone, a gaming system console or personal computing device, it will be understood that the present invention is applicable to any suitable 3D enabled device configured to produce stereoscopic images on a display.

The system 100 includes a central processing unit (CPU) 102 arranged to control and coordinate operations in the system 100, including for example controlling basic operation of the 3D enabled device and implementation of 3D enabled games, a data storage device 104 arranged to store programs and/or data for use by the CPU 102 to implement functionality in the 3D enabled device, and a CPU memory 106 arranged to temporarily store programs and/or data for use by the CPU 102.

The system 100 also includes a graphics processing unit (GPU) 108 arranged to control and coordinate graphics rendering operations including stereoscopic rendering operations for 3D applications, a GPU data storage device 110 arranged to store programs and/or data for use by the GPU 108 to implement graphics rendering processes, and a GPU memory 112 arranged to temporarily store programs and/or data for use by the GPU 108.

The system 100 also includes a video memory 114 that may be separate to or the same component as the GPU memory 112. The video memory 114 is used to store several image buffers used to render stereoscopic images for use by the display 128, and in this example the buffers include a display buffer 116 used to store information indicative of an image to be displayed by the display 128, a back buffer 118 in which image information is initially rendered prior to transference to the display buffer and thereby display on the display 128, and a depth (Z) buffer 120.

The video memory 114 also includes one or more off-screen buffers 122 used to add other functionality to the rendering operations, for example a stencil buffer usable to add features such as shadows to a rendered image.

An I/O controller 124 is also provided to coordinate communications between the CPU 102, GPU 108, data storage, memory and interface devices 126 of the system 100.

It will be understood that a depth (Z) buffer is used to store depth information for each pixel during rendering of an image so that only objects in the foreground of a scene are ultimately rendered. For example, during rendering of a scene in a game implemented by a gaming system or computing device, each graphics primitive associated with the scene is subjected to a depth test wherein a depth value associated with each pixel of the primitive is compared with a depth value stored at a corresponding location in the depth buffer. If the pixel passes the depth test, for example because the depth value of the primitive is greater than (or in some implementations less than) the depth value in the Z buffer, the pixel is drawn to the display buffer and the depth value in the Z buffer is replaced by the depth value of the pixel. In this way, the rendering system ensures that only pixels that are foremost in a scene are ultimately rendered to the display buffer and shown on the display.

The system 100 also includes graphics resources 130 that may be stored on a hard drive associated with the gaming system or computing device, or may be stored on a removable storage medium, such as an optical disk, that also includes instructions and data for implementing a game or application by the gaming system or computing device.

The stereoscopic rendering system 100, in this example the GPU 108 uses the Z buffer 120 to perform a stenciling type function in addition to a depth management function by configuring the data in the Z buffer so that alternate portions of the Z buffer are distinguished from each other and correspond respectively to two different views of a scene as required by the stereo view configuration of the 3D display. In the present example, the alternate portions are vertical stripes, although it will be understood that other arrangements for current and future 3D display systems are possible, such as horizontal or diagonal stripes, or curved portions. As a further alternative, left and right views may be alternately disposed in horizontal and vertically disposed portions that together define a checkerboard type configuration.

The alternate vertical stripes in this example are distinguished from each other by allocating different ranges of depth values to the alternate stripes. In the present embodiment, a first set of stripes are allocated a depth value range between 0 and 0.5, and a second set of stripes alternately disposed relative to the first set of stripes are allocated a depth value range between 0.5 and 1.

The depth values associated with the first set of stripes are such that higher numerical depth values correspond to objects that are closer to the foreground. In contrast, the depth values associated with the second set of stripes are such that lower numerical depth values correspond to objects that are closer to the foreground.

By controlling the depth test so as to draw only those pixels that correspond to the foreground and that fall within the respective depth range (0 to 0.5 or 0.5 to 1), the two different views of the scene can be rendered directly into the display buffer as the alternate views of the scene are processed during rendering.

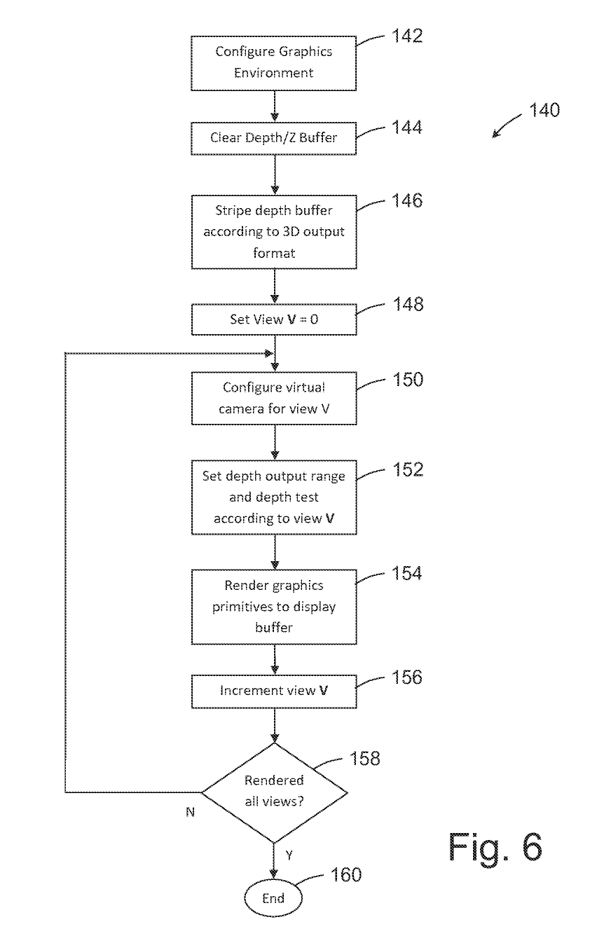

An example method of rendering stereoscopic images according to an embodiment of the invention and using a stereoscopic rendering system as shown in FIG. 5 is illustrated in flow diagram 140 in FIG. 6.

The graphics environment is first configured 142 for rendering, the depth (Z) buffer 120 is cleared 144, and stripes are drawn 146 into the Z buffer 120 by populating alternate vertical portions of the Z buffer with respective different initial depth values. After initializing the Z buffer, a first of multiple views is selected 148, and a virtual camera is configured for the selected view.

The depth test corresponding to the selected view is then selected 152, and graphics primitives associated with the selected view are retrieved from the graphics resources 130 and tested against the depth values in the Z buffer according to the selected depth test. If the depth value of a graphics primitive passes the depth test and falls within the depth range associated with the selected view, the graphics primitive is drawn 154 into the display buffer.

The view is then incremented 156 and the process of configuring the virtual camera 150, setting and applying the depth range 152 and rendering graphics primitives to the display buffer 154 continues until all views have been processed. When this occurs, the process turns to the next scene and the stereoscopic rendering process repeats.

Importantly, the depth values in the striped depth buffer and the applied depth test ensure that for each view graphics primitives are ultimately drawn into the display buffer only in the areas of the display buffer that correspond to the view and in accordance with the specific view arrangement of the 3D display device.

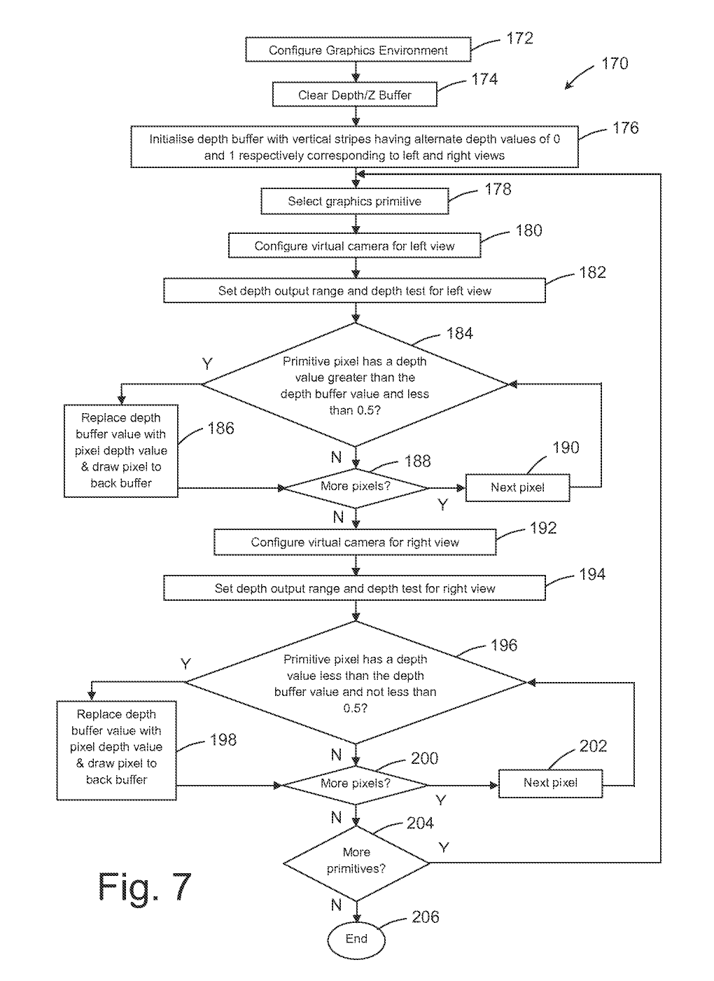

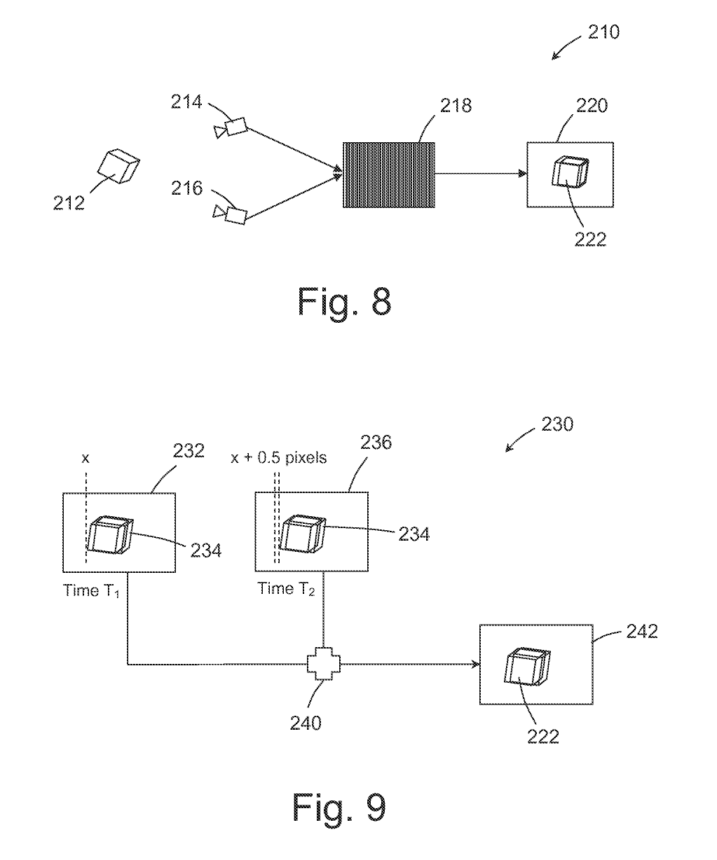

An example stereoscopic rendering process for a stereoscopic rendering system 210 that includes two views corresponding to left and right eyes of a viewer is illustrated by flow diagram 170 shown in FIG. 7 and an example system 210 shown in FIG. 8.

The graphics environment is first configured 172 for rendering a scene, and the depth (Z) buffer 218 is cleared 174. Vertical stripes are then drawn 176 into the Z buffer 218 such that a first set of stripes (corresponding in this example to the left eye view) are populated with depth values equal to 0 and a second set of stripes (corresponding in this example to the right eye view and alternately disposed relative to the first stripes) are populated with depth values equal to 1.

After initializing the Z buffer 218, a first graphics primitive 212 for the scene is retrieved 178 from the graphics resources 130, a left view for the primitive is selected, and a virtual camera 214 is configured 178 for the left view.

The depth test corresponding to the left view is then selected 180, and the depth range for the left view defined as between 0 and 0.5. For the left view, the depth test is such that only pixels of the graphics primitive 212 having a depth value greater than the corresponding value in the depth buffer and less than 0.5 are drawn to a display buffer 220. This ensures that for the left view pixels are only drawn to the display buffer in stripes that correspond to the left view stripes in the Z buffer 218.

After defining the depth range and depth test for the left view of the graphics primitive 212, the pixels of the graphics primitive 212 are tested against the depth values in the Z buffer 218 according to the selected the depth test. If the depth value of a pixel of the graphics primitive 212 passes the depth test and is within the 0-0.5 depth range associated with the left view, the pixel is drawn 184 into the display buffer 220 and the depth value in the Z buffer is replaced by the depth value of the drawn pixel.

The rendering process for the left view continues until all pixels of the graphics primitive 212 have been tested.

After all pixels for the left view of the graphics primitive 212 have been tested according to the depth test, the right view is selected, and a virtual camera 216 configured 190 for the right view.

The depth test corresponding to the right view is then selected 192, and the depth range for the right view defined as between 0.5 and 1. For the right view, the depth test is such that only pixels of the graphics primitive 212 having a depth value less than the corresponding value in the depth buffer 218 and greater than 0.5 are drawn to the display buffer 220. This ensures that for the right view pixels are only drawn to the display buffer in stripes that correspond to the right view stripes in the Z buffer 218.

After defining the depth range and depth test for the right view of the graphics primitive 212, the pixels of the graphics primitive are tested against the depth values in the Z buffer 218 according to the selected the depth test. If the depth value of a pixel of the graphics primitive 212 passes the depth test and is within the 0.5-1 depth range associated with the right view, the pixel is drawn 196 into the display buffer and the depth value in the Z buffer is replaced by the depth value of the drawn pixel.

The rendering process for the right view continues until all pixels of the graphics primitive 212 have been tested 198, 200.

After both left and right views have been rendered into the display buffer 220, a combined view 222 including interleaved stripes corresponding respectively to the left and right views is produced.

If more primitives are present in the scene, the next primitive is selected and the above process carried out in relation to the next and subsequent primitives.

After all graphics primitives have been tested according to the depth tests for the left and right views, the process turns to the next scene and repeats.

While the above example is described in relation to an arrangement whereby each primitive is processed for both left and right views in turn, it will be understood that other arrangements are possible. For example, the left view for all primitives may be processed first followed by the right view for all primitives.

In some circumstances it is desired to overlay objects over the displayed image irrespective of whether the object passes the depth test for the left or right view. For this purpose, an overlay depth value or overlay depth value range different to the depth value ranges associated with the at least two depth buffer portions is defined, and the system arranged to render pixels that have a depth value corresponding to the overlay depth value or falling within the overlay depth value range from any of the views to the image buffer. In an example, the overlay depth value range may be defined between the depth ranges associated with the left and right views, in the above example at about 0.5.

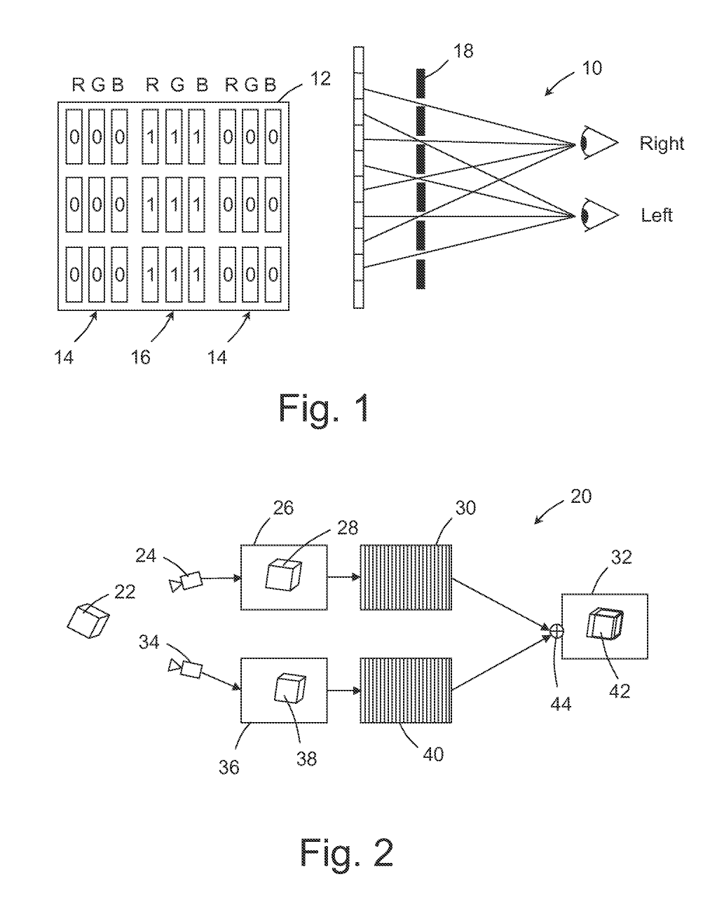

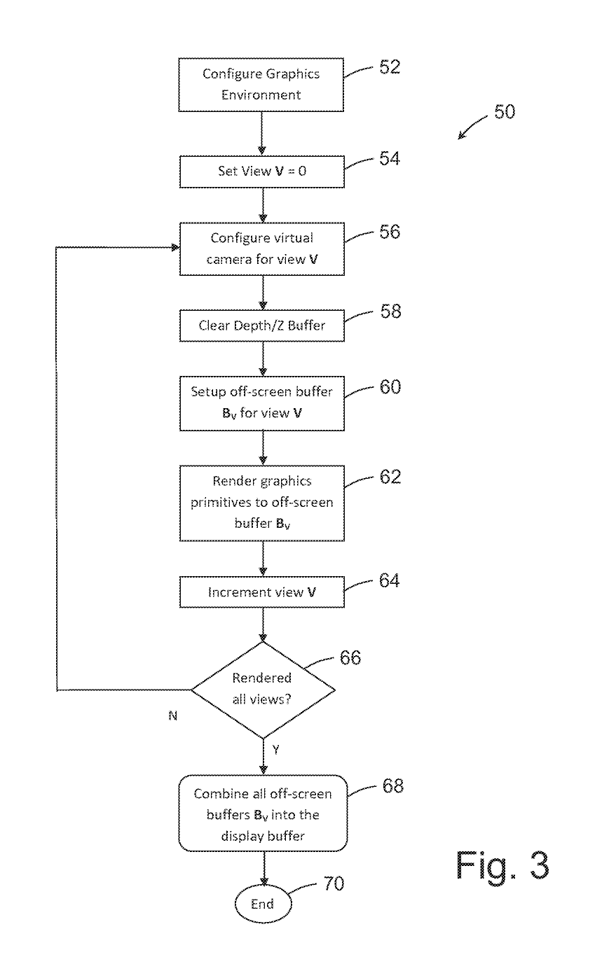

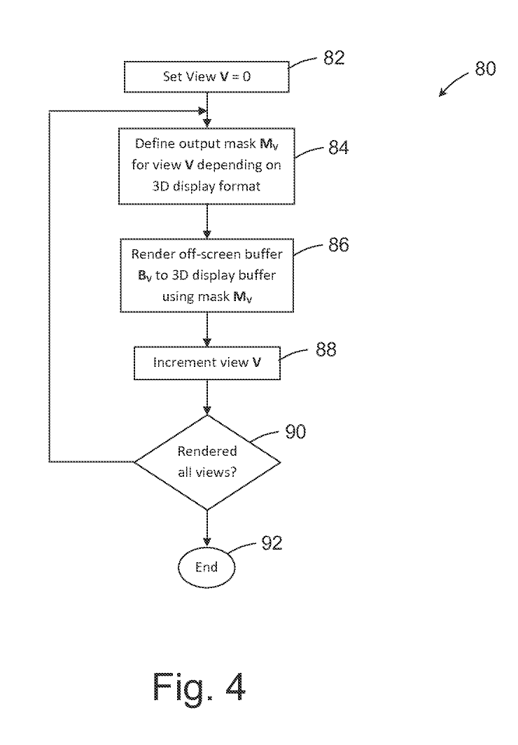

It will be appreciated that with the present stereoscopic rendering system, performance improvements are achieved relative to the prior art system and method shown in FIGS. 1 to 4 since the left and right views are rendered directly into the display buffer without any intermediate buffering, and this is achieved without using the stencil buffer or any additional GPU memory.

It will also be appreciated that since with the present system intermediate left and right views are not produced, conventional anti-aliasing techniques cannot be used because a full left and full right view does not exist in any buffer and the display buffer includes interleaved left and right views.

An anti-aliasing system 230 suitable for use with the stereoscopic rendering system 100 is shown in FIG. 9.

The anti-aliasing system 230 is implemented in this example using the GPU 108 and associated programs stored in the GPU data storage device 110 and GPU memory 112, although it will be understood that other implementations are envisaged.

The representation of the anti-aliasing system 230 in FIG. 9 shows a representation 232 of a combined left and right view of a primitive 234 at a first time T1. The anti-aliasing system 230 is arranged to generate a further representation 236 of the combined left and right view of the primitive 234 at a second time T2, in this example by shifting the representation right by 0.5 pixels.

The representation 232 and the further representation 236 are then input to a blender 240 arranged to average or otherwise process the representations 232, 236 in order to cause smoothing of the respective left and right views that make up the combined view that is rendered into the display buffer 242. For example, linear or non-linear operations using multiple pixels from spatial and/or temporal sampling intervals may be combined to provide an optimal anti-aliasing scheme dependent on the nature of the graphics primitives being rendered and the view arrangement on the 3D display device.

While the present example is described in relation to a process whereby a further view is produced by shifting an originally produced representation to the right, it will be understood that alternatively the originally produced representation may be shifted to the left.

In addition, it will be understood that for stereoscopic systems that use other arrangements for separating left and right views, for example by using horizontal portions instead of vertical portions, other shifting operations are envisaged, the important aspect being that at least one further representation of a generated combined view is produced that is shifted relative to the originally produced representation, and the originally produced representation and at least one further representations are blended so as to produce a smoother image.

In one arrangement multiple temporal sampling points may be produced, for example at time T1, T2, T3, T4 and the results averaged, such as using linear or non-linear averaging techniques.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Modifications and variations as would be apparent to a skilled addressee are determined to be within the scope of the present invention.

1. A stereoscopic rendering system comprising:
a depth buffer having at least two depth buffer portions respectively corresponding to different views of a scene, the depth buffer arranged to store depth values indicative of the depth of pixels in a scene, and the depth buffer portions having different associated depth value ranges so that the different depth buffer portions are distinguishable from each other;
an image buffer arranged to store information indicative of an image to be displayed;
wherein the system is arranged to apply a different depth test for each view of the scene such that only pixels of the view that spatially correspond to the depth buffer portion associated with the view are rendered to the image buffer; and
wherein the image thereby rendered into the image buffer comprises image portions respectively spatially corresponding to the different depth buffer portions and the different views of the scene.

2. A stereoscopic rendering system as claimed in claim 1, wherein the depth buffer portions include a first set of depth buffer portions and a second set of depth buffer portions alternately disposed relative to the first set of depth buffer portions.

3. A stereoscopic rendering system as claimed in claim 2, wherein the alternate first and second sets of depth buffer portions define a plurality of stripes.

4. A stereoscopic rendering system as claimed in claim 3, wherein the stripes extend vertically or horizontally.

5. A stereoscopic rendering system as claimed in claim 1, wherein two sets of depth buffer portions are provided respectively corresponding to left and right views of a scene.

6. A stereoscopic rendering system as claimed in claim 2, wherein the depth value range for the first set of depth buffer portions is numerically adjacent the depth value range for the second set of depth buffer portions.

7. A stereoscopic rendering system as claimed in claim 6, wherein the depth value range for a first set of depth buffer portions is 0 to 0.5, and the depth value range for a second set of depth buffer portions is 0.5 to 1.

8. A stereoscopic rendering system as claimed in claim 2, wherein the system is arranged such that increasing magnitude depth values in the first set of depth buffer portions is indicative of increasing closeness to the foreground of a scene, and decreasing magnitude depth values in the second set of depth buffer portions is indicative of increasing closeness to the foreground of a scene.

9. A stereoscopic rendering system as claimed in claim 8, wherein the system is arranged to apply a depth test to a first view of a scene such that only pixels associated with the first view of the scene that have a depth value greater than the corresponding depth value in the depth buffer and within the depth range for the first set of depth buffer portions are rendered to the image buffer.

10. A stereoscopic rendering system as claimed in claim 8, wherein the system is arranged to apply a depth test to a second view of a scene such that only pixels associated with the second view of the scene that have a depth value less than the corresponding depth value in the depth buffer and within the depth range for the second set of depth buffer portions are rendered to the image buffer.

11. A stereoscopic rendering system as claimed in claim 1, wherein the system is arranged to replace the depth value in a depth buffer portion with a depth value associated with a pixel of a view of a scene if the depth value associated with the pixel passes the depth test associated with the view of the scene.

12. A stereoscopic rendering system as claimed in claim 7, wherein the system is arranged to initialize the depth buffer portions by populating the depth buffer portions with defined initial depth values.

13. A stereoscopic rendering system as claimed in claim 12, wherein the defined initial depth value for the first set of depth buffer portions is 0, and the defined initial depth value for the second set of depth buffer portions is 1.

14. A stereoscopic rendering system as claimed in claim 1, wherein an overlay depth value or overlay depth value range different to the depth value ranges associated with the at least two depth buffer portions is defined, and the system is arranged to render pixels that have a depth value corresponding to the overlay depth value or falling within the overlay depth value range from any of the views to the image buffer.

15. A stereoscopic rendering system as claimed in claim 14, wherein the overlay depth value range is defined between the depth ranges associated with the first and second sets of depth buffer portions.

16. A stereoscopic rendering system as claimed in claim 1, comprising an anti-aliasing system, the anti-aliasing system arranged to generate a second image using a first image rendered into the image buffer, and to generate a smoothed image using the first and second images.

17. A stereoscopic rendering system as claimed in claim 16, wherein the second image is generated by spatially shifting the first image.

18. A stereoscopic rendering system as claimed in claim 16, wherein the anti-aliasing system is arranged to generate a smoothed image by combining spatial and/or temporal sampling intervals.

19. A stereoscopic rendering system as claimed in claim 16, wherein multiple temporally spaced images are produced and the multiple temporally spaced images used to produce a smoothed image.

20. A method of rendering stereoscopic images, the method comprising:
providing a depth buffer having at least two depth buffer portions respectively corresponding to different views of a scene;
storing in the depth buffer depth values indicative of the depth of pixels in a scene, the depth buffer portions having different associated depth value ranges so that the different depth buffer portions are distinguishable from each other, and the depth buffer portions being arranged so as to conform with a view arrangement of an associated 3D display system;
providing an image buffer arranged to store information indicative of an image to be displayed; and
applying a different depth test for each view of the scene such that only pixels of the view that spatially correspond to the depth buffer portion associated with the view are rendered to the image buffer;
wherein the image thereby rendered into the image buffer comprises image portions respectively spatially corresponding to the different depth buffer portions and the different views of the scene.

21. A method as claimed in claim 20, wherein the depth buffer portions include a first set of depth buffer portions and a second set of depth buffer portions alternately disposed relative to the first set of depth buffer portions.

22. A method as claimed in claim 21, wherein the alternate first and second sets of depth buffer portions define a plurality of stripes.

23. A method as claimed in claim 22, wherein the stripes extend vertically or horizontally.

24. A method as claimed in claim 21, comprising providing two sets of depth buffer respectively corresponding to left and right views of a scene.

25. A method as claimed in claim 21, wherein the depth value range for the first set of depth buffer portions is numerically adjacent the depth value range for the second set of depth buffer portions.

26. A method as claimed in claim 25, wherein the depth value range for one of the first and second sets of depth buffer portions is 0 to 0.5, and the depth value range for the other of the first and second sets of depth buffer portions is 0.5 to 1.

27. A method as claimed in claim 21, wherein increasing magnitude depth values in the first set of depth buffer portions is indicative of increasing closeness to the foreground of a scene, and decreasing magnitude depth values in the second set of depth buffer portions is indicative of increasing closeness to the foreground of a scene.

28. A method as claimed in claim 27, comprising applying a depth test to a first view of a scene such that only pixels associated with the first view of the scene that have a depth value greater than the corresponding depth value in the depth buffer and within the depth range for the first set of depth buffer portions are rendered to the image buffer.

29. A method as claimed in claim 27, comprising applying a depth test to a second view of a scene such that only pixels associated with the second view of the scene that have a depth value less than the corresponding depth value in the depth buffer and within the depth range for the second set of depth buffer portions are rendered to the image buffer.

30. A method as claimed in claim 20, comprising replacing the depth value in a depth buffer portion with a depth value associated with a pixel of a view of a scene if the depth value associated with the pixel passes the depth test associated with the view of the scene.

31. A method as claimed in claim 26, comprising initializing the depth buffer portions by populating the depth buffer portions with defined initial depth values.

32. A method as claimed in claim 31, wherein the defined initial depth value for the first set of depth buffer portions is 0, and the defined initial depth value for the second set of depth buffer portions is 1.

33. A method as claimed in claim 20, comprising defining an overlay depth value or overlay depth value range different to the depth value ranges associated with the at least two depth buffer portions, and rendering pixels that have a depth value corresponding to the overlay depth value or falling within the overlay depth value range from any of the views to the image buffer.

34. A method as claimed in claim 33, comprising defining the overlay depth value range between the depth ranges associated with the first and second sets of depth buffer portions.

35. A method as claimed in claim 20, comprising generating a second image using a first image rendered into the image buffer, and generating a smoothed image using the first and second images.

36. A method as claimed in claim 35, comprising generating the second image by spatially shifting the first image.

37. A method as claimed in claim 35, comprising generating a smoothed image by combining spatial and/or temporal sampling intervals.

38. A method as claimed in claim 35, comprising producing multiple temporally spaced images and using the multiple temporally spaced images to produce a smoothed image.
